(19) United States
(12) Patent Application Publication
(10) Pub. No.: US 2011/0120192 A1
(43) Pub. Date: May 26, 2011

(54) Fluid balancer and washing machine having the same

(75) Inventor: Chang Min Song, Hwaseong-si (KR)

(73) Assignee: SAMSUNG ELECTRONICS CO., LTD., Suwon-si (KR)

(21) Appl. No.: 12/926,139

(22) Filed: Oct. 27, 2010

(30) Foreign Application Priority Data
Nov. 24, 2009 (KR) 10-2009-113643

(51) Int. Cl. D06F 37/24; F16F 15/32

(52) U.S. Cl. 68/23.2; 74/572.4

(57) ABSTRACT

The fluid balancer includes balancer housings in which ring-shaped flow chambers partially filled with a fluid are provided, and a plurality of guides disposed in the flow chambers and separated from each other in the circumferential direction of the flow chambers. The plurality of guides is provided with first communication holes provided on inner peripheral sides of the balancer housings and second communication holes provided on outer peripheral sides of the balancer housings, and the performance of the fluid balancer is improved by adjusting an area of the second communication holes and a volume filling each of the flow chambers.

### CROSS-REFERENCE TO RELATED APPLICATIONS

This application claims the benefit of Korean Patent Application No. 2009-0113643, filed on Nov. 24, 2009 in the Korean Intellectual Property Office, the disclosure of which is incorporated herein by reference.

### BACKGROUND

1. Field

Embodiments relate to a fluid balancer which enables rotation of a drum to be rapidly stabilized, and a washing machine having the same.

2. Description of the Related Art

In general, washing machines are apparatuses which wash laundry through washing, rinsing, and spin-drying cycles.

Each of these washing machines includes a housing forming an external appearance of the washing machine, a tub disposed in the housing to contain water, a drum rotatably installed in the tub such that laundry is placed in the drum, a pulsator rotatably installed in the drum to generate a water current, and a driving device generating rotary force to rotate the drum and the pulsator. The drum and the pulsator are rotated in a regular or reverse direction through the driving device, thereby enabling the laundry in the drum to be washed through friction.

Recently, among the washing machines, there is a washing machine in which a fluid balancer is installed on a drum so as to rapidly stabilize rotation of the drum.

The fluid balancer is ring-shaped and includes balancer housings in which a ring-shaped flow chamber partially filled with a fluid is provided. The fluid moves to a position opposite to an unbalanced mass generated in the drum according to rotation of the drum, and thus causes the center of rotation of the drum and the center of gravity of the drum to coincide with each other, thereby being capable of rapidly stabilizing rotation of the drum.

### SUMMARY

Therefore, it is an aspect to provide a fluid balancer having optimized performance and a washing machine having the same.

Additional aspects will be set forth in part in the description which follows and, in part, will be apparent from the description, or may be learned by practice of the invention.

In accordance with one aspect, a fluid balancer includes balancer housings in which ring-shaped flow chambers partially filled with a fluid are provided, and a plurality of guides disposed in the flow chambers and separated from each other in the circumferential direction of the flow chambers, wherein the plurality of guides is provided with first communication holes provided on inner peripheral sides of the balancer housings and second communication holes provided on outer peripheral sides of the balancer housings, and an area of the second communication holes is more than 1% of a cross-sectional area of each of the flow chambers and less than 4% of the cross-sectional area of each of the flow chambers.

A volume of the fluid filling each of the flow chambers may be in the range of 32˜40% of a volume of each of the flow chambers.

Further, the volume of the fluid filling each of the flow chambers may be 36% of the volume of each of the flow chambers.

Protrusions protruded from the inner peripheral sides of the balancer housings to the insides of the flow chambers may be provided on the balancer housings.

The balancer housings may include a first ring-shaped balancer housing provided with one opened side, and a second ring-shaped balancer housing corresponding to the first balancer housing and covering the opened side of the first balancer housing.

The plurality of guides may include first guides extended from the first balancer housing and second guides extended from the second balancer housing, and the first communication holes and the second communication holes may be provided between the first guides and the second guides.

In accordance with another aspect, a fluid balancer includes balancer housings in which ring-shaped flow chambers partially filled with a fluid are provided, wherein a volume of the fluid filling each of the flow chambers is in the range of 32˜40% of a volume of each of the flow chambers.

In accordance with another aspect, a washing machine includes a drum, and a fluid balancer installed on the drum and including balancer housings in which ring-shaped flow chambers partially filled with a fluid are provided, and a plurality of guides disposed in the flow chambers and separated from each other in the circumferential direction of the flow chambers, wherein the plurality of guides is provided with first communication holes provided on inner peripheral sides of the balancer housings and second communication holes provided on outer peripheral sides of the balancer housings, and an area of the second communication holes is more than 1% of a cross-sectional area of each of the flow chambers and less than 4% of the cross-sectional area of each of the flow chambers.

In accordance with a further aspect, a washing machine includes a fluid balancer including balancer housings in which ring-shaped flow chambers partially filled with a fluid are provided, wherein a volume of the fluid filling each of the flow chambers is in the range of 32˜40% of a volume of each of the flow chambers.

### BRIEF DESCRIPTION OF THE DRAWINGS

These and/or other aspects will become apparent and more readily appreciated from the following description of the embodiments, taken in conjunction with the accompanying drawings of which:

FIG. 1 is a longitudinal-sectional view of a washing machine in accordance with one embodiment;

FIG. 2 is an exploded perspective view of a fluid balancer applied to the washing machine in accordance with the embodiment;

FIG. 3 is a longitudinal-sectional view of the fluid balancer applied to the washing machine in accordance with the embodiment;

FIGS. 4 to 7 are schematic views illustrating a fluid flowing operation of the fluid balancer according to rotation of a drum; and

FIGS. 8 to 10 are graphs illustrating performance of the fluid balancer according to an area of second communication holes provided on guides and a volume of a fluid filling the fluid balancer.

### DETAILED DESCRIPTION

Reference will now be made in detail to the embodiments, examples of which are illustrated in the accompanying drawings, wherein like reference numerals refer to like elements throughout.

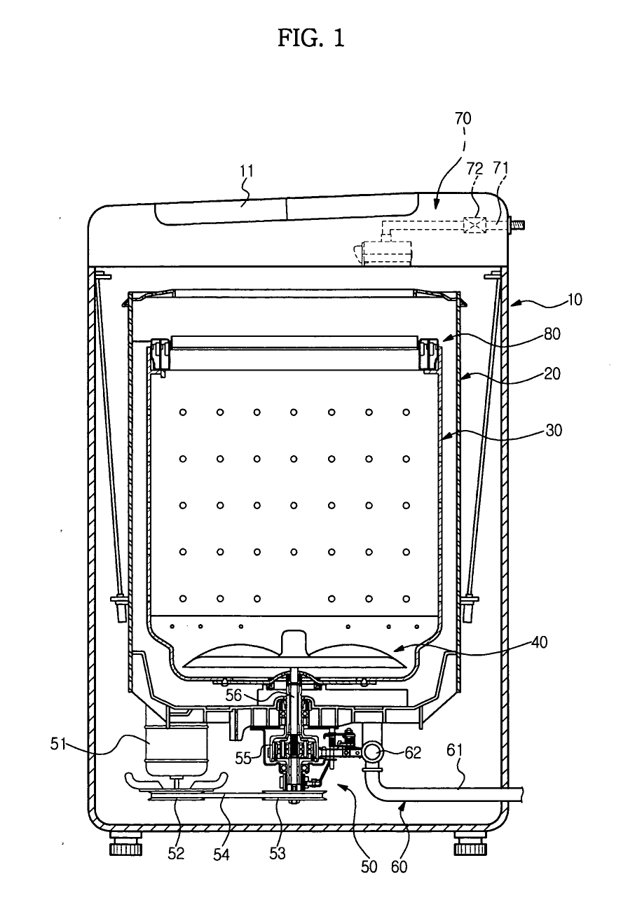

As shown in FIG. 1, a washing machine in accordance with one embodiment includes a housing 10 forming an external appearance of the washing machine, a tub 20 disposed in the housing 10 to contain water, a drum 30 rotatably installed in the tub 20 such that laundry is placed in the drum 30, and a pulsator 40 rotatably installed on the bottom of the inside of the drum 30 and rotated to generate a water current so as to wash the laundry in the drum 30 through friction.

The housing 10 is provided with an opened upper surface through which the laundry is put into the drum 30, and a door 11 rotated in the vertical direction to open and close the opened upper surface of the housing 10 is installed at the rear portion of the upper surface of the housing 10.

A driving device 50 to rotate the drum 30 and the pulsator 40 and a drain device 60 to discharge the water contained in the tub 20 to the outside after washing are installed in the lower portion of the housing 10, and a water supply device 70 to supply water to the tub 20 is installed in the upper portion of the housing 10.

The driving device 50 includes a driving motor 51 generating rotary force, a power transmission device 55 receiving the rotary force generated from the driving motor 51 through a pair of pulleys 52 and 53 and a belt and then transmitting the rotary force selectively to the drum 30 and the pulsator 40, and a rotary shaft 56 provided with one end connected to the pulsator 40 and the other end connected to the power transmission device 55 to transmit the rotary force to the pulsator 40.

The drain device 60 includes a drain pipe 61 to guide the water in the tub 20 so as to drain the water, and a drain valve 62 to open and close the drain pipe 61 in connection with the power transmission device 55. The water supply device 70 includes a water supply pipe 71 to guide water from an external water supply source to the tub 20, and a water supply valve 72 installed on the water supply pipe 71 to open and close the water supply pipe 71.

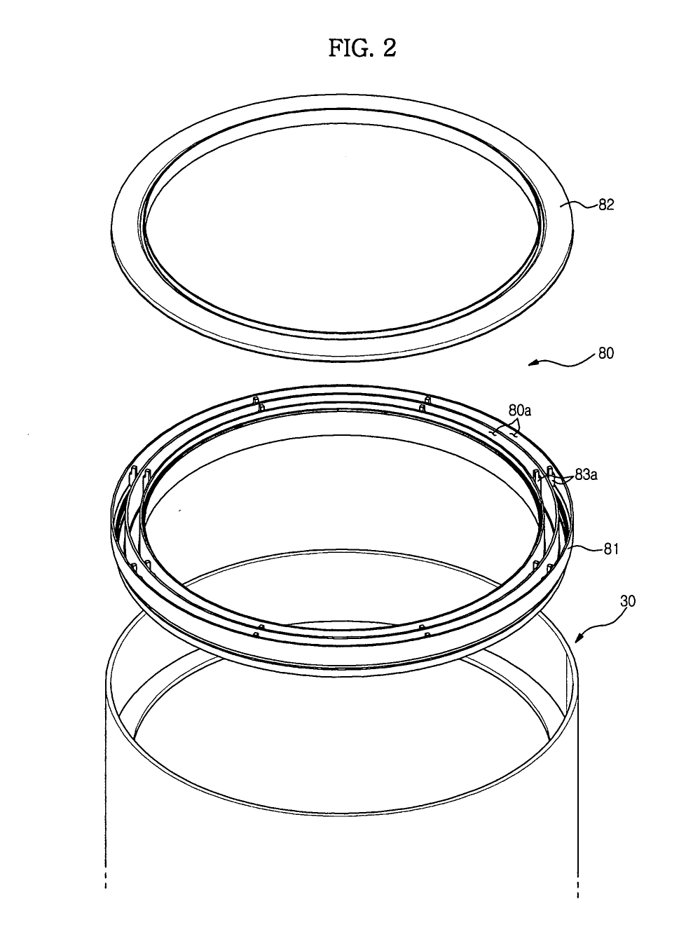

The washing machine further includes a fluid balancer 80 to rapidly stabilize rotation of the drum 30. The fluid balancer 80, as shown in FIG. 2, includes ring-shaped balancer housings 81 and 82 disposed such that the centers of gravity of the balancer housings 81 and 82 are coaxial with the center of rotation of the drum 30, and flow chambers 80a which are ring-shaped and are partially filled with a fluid are provided in the balancer housings 81 and 82. In this embodiment, the fluid balancer 80 is installed at the upper end of the drum 30, and a pair of flow chambers 80a is provided in parallel in the radial direction of the balancer housings 81 and 82.

The balancer housings 81 and 82 include a first balancer housing 81, which is ring-shaped, and one side of which is opened so as to fill the first balancer housing 81 with the fluid therethrough, and a second balancer housing 82, which is ring-shaped corresponding to the first balancer housing 81 and covers the opened side of the first balancer housing 81 so as to form the flow chambers 80a together with the first balancer housing 81.

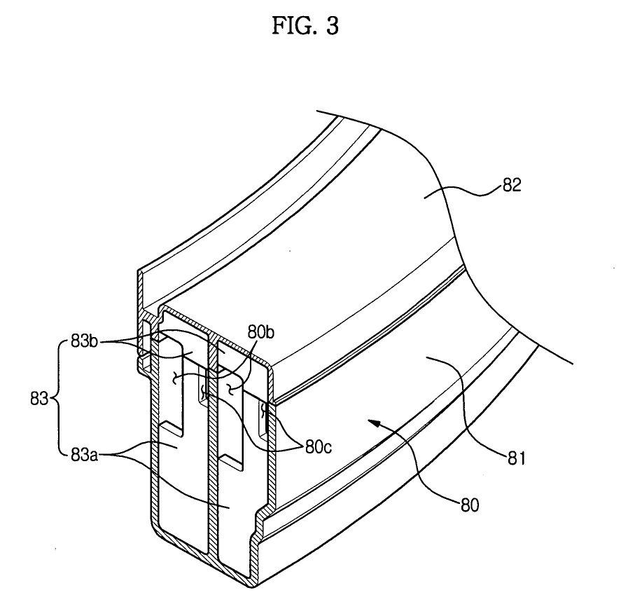

A plurality of guides 83 is disposed in the flow chamber 80a such that the guides 83 are separated from each other by regular intervals in the circumferential direction, thereby enabling the fluid in the flow chamber 80a to flow in the circumferential direction according to rotation of the drum 30. As shown in FIG. 3, communication holes 80b and 80c to enable the fluid to pass through the guides 83 and then to flow in the circumferential direction are provided on the guides 83.

The communication holes 80b and 80c include first communication holes 80b provided on inner peripheral sides of the balancer housings 81 and 82, and second communication holes 80c provided on outer peripheral sides of the balancer housings 81 and 82. The first communication holes 80b serve to move the fluid in the horizontal direction under the condition that the drum 30 is stopped, and thus to uniformly distribute the fluid throughout the flow chambers 80a. The second communication holes 80c serve to enable the fluid to pass through the guides 83 under the condition that the fluid within the flow chambers 80a moves to the inner surfaces of the outer peripheral sides of the balancer housings 81 and 82 due to centrifugal force according to rotation of the drum 30, and thus to enable the fluid to have a continuous surface via two neighboring spaces divided by one guide 83.

In this embodiment, the guides 83 include a plurality of first guides 83a provided on the first balancer housing 81, and a plurality of second guides 83b provided on the second balancer housing 82 respectively corresponding to the plurality of first guides 83a. Therefore, when the first balancer housing 81 and the second balancer housing 82 are connected to each other such that the first guides 83a and the second guides 83b are located at corresponding positions, the flow chambers 80a are divided in the circumferential direction by the first guides 83a and the second guides 83b, and the first communication holes 80b and the second communication holes 80c are provided between the first guides 83a and the second guides 83b disposed at the corresponding positions.

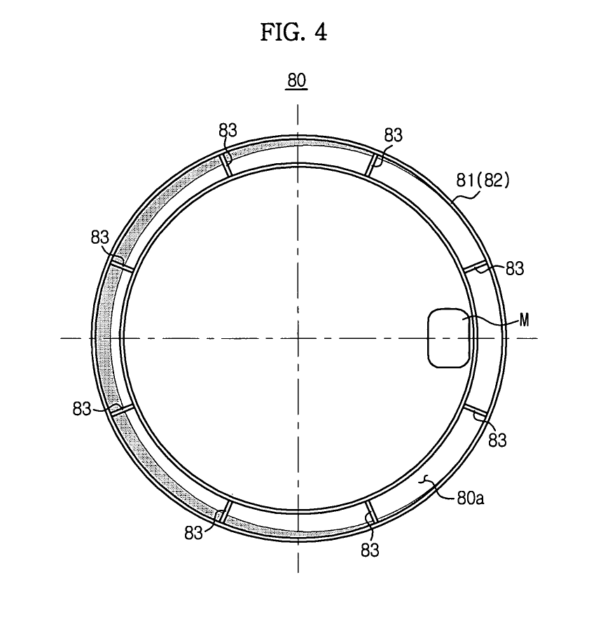

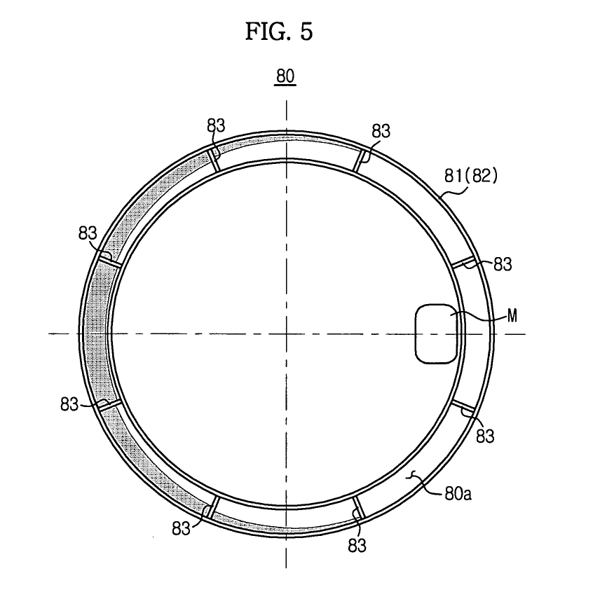

Here, if the drum 30 is rotated, the fluid within the flow chamber 80a may continuously flow to a position symmetrically opposite to a position where an unbalanced mass M occurs, as shown in FIG. 4. If an area of the second communication holes 80c is less than 1% of a cross-sectional area of the flow chamber 80a, only an extremely small amount of the fluid passes through the guides 83, and surfaces of the fluid located at two neighboring spaces divided by the guide 83 are discontinuous, as shown in FIG. 5. The performance of the fluid balancer 80 if the surfaces of the fluid are discontinuous is lower than that of the fluid balancer 80 if the surfaces of the fluid are continuous.

On the other hand, if the area of the second communication holes 80c is more than 4% of the cross-sectional area of the flow chamber 80a, the fluid does not receive sufficient force transmitted through the guides 83 when the drum 30 is rotated, and thereby the velocity of the fluid flowing along the flow chamber 80a does not keep up with the rotating velocity of the balancer housings 81 and 82. In this case, an amplitude of vibration of the drum 30 on which the fluid balancer 80 is installed is periodically raised and lowered.

Accordingly, if the area of the second communication holes 80c is more than 1% of the cross-sectional area of the flow chamber 80a and is less than 4% of the cross-sectional area of the flow chamber 80a, the fluid flowing in the flow chamber 80a according to rotation of the drum 30 has a continuous surface and flows at a proper velocity in the flow chamber 80a according to rotation of the fluid balancer 80.

Further, the performance of the fluid balancer 80 is determined according to an amount of the fluid filling the flow chambers 80a of the balancer housings 81 and 82. It has been discovered that the fluid balancer 80 generally has the highest performance if a volume of the fluid is about 47˜51% of an inner volume of the flow chamber 80a.

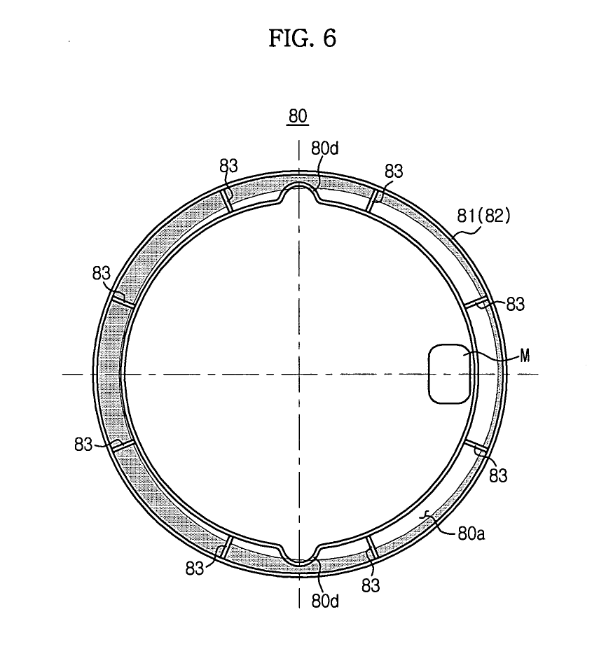

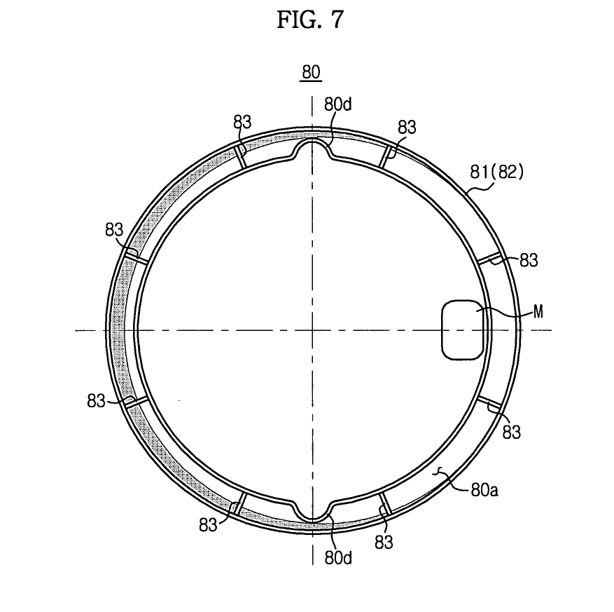

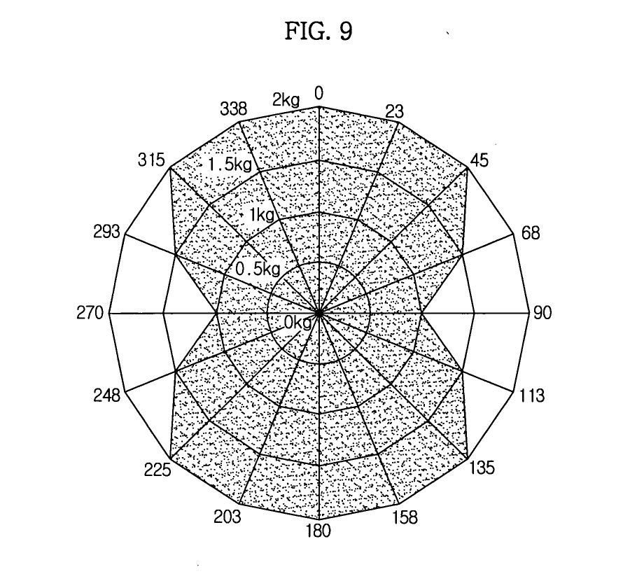

However, as shown in FIG. 6, in order to form a structure for installation of the fluid balancer 80 on the drum 30 on the fluid balancer 80, a pair of protrusions 80d protruded from the inner peripheral sides of the balancer housings 81 and 82 toward the inside of the flow chamber 80a is formed at both sides of the balancer housings 81 and 82. The protrusions 80d interfere with the fluid flowing along the flow chamber 80a, and the flow of the fluid is disturbed by the protrusions 80d. Thus, the performance of the fluid balancer 80 is lowered, and a variation of the unbalanced mass M to be balanced according to position occurs, as shown in FIG. 9.

Accordingly, if the volume of the fluid filling the flow chamber 80a is 32˜40% of the volume of the flow chamber 80a in order to prevent the fluid from interfering with the protrusions 80d while flowing along the flow chamber 80a according to rotation of the drum 30, disturbance of the flow of the fluid by the protrusions 80d while flowing along the flow chamber 80a according to rotation of the drum 30 is prevented, and thus the performance of the fluid balancer 80 is improved. If the volume of the fluid filling the flow chamber 80a is 36% of the volume of the flow chamber 80a, the fluid balancer 80 exhibits optimum performance.

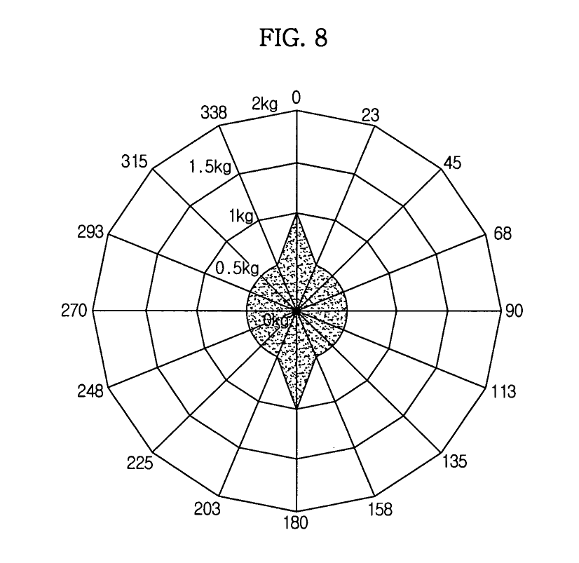

FIG. 8 illustrates the performance of the fluid balancer 80 if the area of the second communication holes 80c is less than 1% of the cross-sectional area of the flow chamber 80a and the volume of the fluid filling the flow chamber 80a provided with the protrusions 80d formed on the balancer housings 81 and 82 is 47˜51% of the volume of the flow chamber 80a.

Further, FIG. 9 illustrates the performance of the fluid balancer 80 if the area of the second communication holes 80c is more than 1% of the cross-sectional area of the flow chamber 80a and less than 4% of the cross-sectional area of the flow chamber 80a and the volume of the fluid filling the flow chamber 80a provided with the protrusions 80d formed on the balancer housings 81 and 82 is 47˜51% of the volume of the flow chamber 80a.

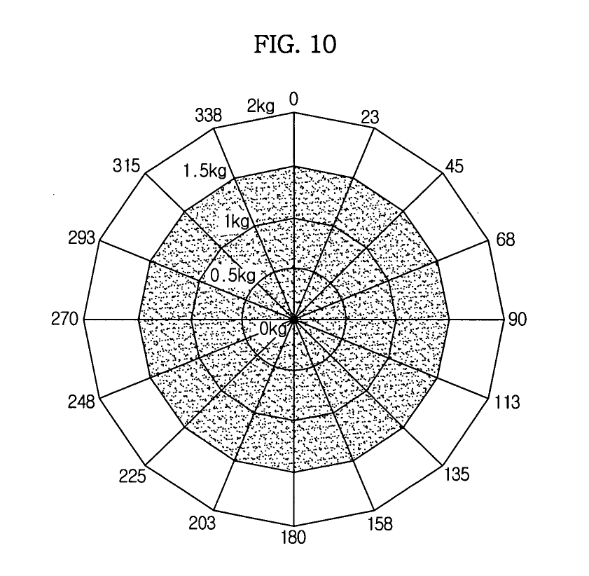

Further, FIG. 10 illustrates the performance of the fluid balancer 80 if the area of the second communication holes 80c is more than 1% of the cross-sectional area of the flow chamber 80a and less than 4% of the cross-sectional area of the flow chamber 80a and the volume of the fluid filling the flow chamber 80a provided with the protrusions 80d formed on the balancer housings 81 and 82 is 32˜40% of the volume of the flow chamber 80a.

Through comparison between FIGS. 8 and 9, it is confirmed that the performance of the fluid balancer 80 is improved, if the area of the second communication holes 80c is more than 1% of the cross-sectional area of the flow chamber 80a and less than 4% of the cross-sectional area of the flow chamber 80a. Through comparison between FIGS. 9 and 10, it is confirmed that the highest performance of the fluid balancer 80 is slightly lowered but directionality of the fluid balancer 80 is removed and the overall performance of the fluid balancer 80 is raised, if the volume of the fluid filling the flow chamber 80a provided with the protrusions 80d formed on the balancer housings 81 and 82 is 32˜40% of the volume of the flow chamber 80a.

Finally, through comparison between FIGS. 8 and 10, it is confirmed that the performance of the fluid balancer 80 if the area of the second communication holes 80c is more than 1% of the cross-sectional area of the flow chamber 80a and less than 4% of the cross-sectional area of the flow chamber 80a and the volume of the fluid filling the flow chamber 80a provided with the protrusions 80d formed on the balancer housings 81 and 82 is 32˜40% of the volume of the flow chamber 80a is raised by three times compared with the performance of the fluid balancer 80 if the area of the second communication holes 80c is less than 1% of the cross-sectional area of the flow chamber 80a and the volume of the fluid filling the flow chamber 80a provided with the protrusions 80d formed on the balancer housings 81 and 82 is 47˜51% of the volume of the flow chamber 80a.

As is apparent from the above description, a fluid balancer and a washing machine having the same in accordance with one embodiment set an area of the second communication holes to be more than 1% of a cross-sectional area of each of flow chambers and less than 4% of the cross-sectional area of each of the flow chambers, thereby enabling the fluid to flow in the flow chambers at a proper velocity according to rotation of the fluid balancer while forming the continuous surface of the fluid flowing in the fluid chambers according to rotation of a drum.

Further, the fluid balancer and the washing machine having the same in accordance with the embodiment of the present invention set a volume of the fluid filling each of the flow chambers to be in the range of 32˜40% of a volume of each of the flow chambers, and thus prevent flow of the fluid from being disturbed by protrusions protruded from an inner peripheral side of the fluid balancer to the inside of the flow chamber during rotation of the fluid balancer, thereby preventing deterioration of the performance of the fluid balancer and removing directionality of the fluid balancer.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A fluid balancer comprising:
balancer housings including ring-shaped flow chambers partially filled with a fluid; and
a plurality of guides disposed in the flow chambers and separated from each other in the circumferential direction of the flow chambers,
wherein the plurality of guides include first communication holes provided on inner peripheral sides of the balancer housings and second communication holes provided on outer peripheral sides of the balancer housings, and
an area of the second communication holes is more than 1% of a cross-sectional area of each of the flow chambers and less than 4% of the cross-sectional area of each of the flow chambers.

2. The fluid balancer according to claim 1, wherein a volume of the fluid filling each of the flow chambers is in the range of 32˜40% of a volume of each of the flow chambers.

3. The fluid balancer according to claim 1, wherein a volume of the fluid filling each of the flow chambers is 36% of a volume of each of the flow chambers.

4. The fluid balancer according to claim 1, wherein the balancer housing further includes protrusions protruded from the inner peripheral sides of the balancer housings to the insides of the flow chambers.

5. The fluid balancer according to claim 1, wherein the balancer housings include a first ring-shaped balancer housing provided with one opened side, and a second ring-shaped balancer housing corresponding to the first balancer housing and covering the opened side of the first balancer housing.

6. The fluid balancer according to claim 5, wherein the plurality of guides includes first guides extended from the first balancer housing and second guides extended from the second balancer housing; and
the first communication holes and the second communication holes are provided between the first guides and the second guides.

7. A fluid balancer comprising balancer housings in which ring-shaped flow chambers partially filled with a fluid are provided, wherein a volume of the fluid filling each of the flow chambers is in the range of 32˜40% of a volume of each of the flow chambers.

8. A washing machine comprising:
a drum; and
a fluid balancer installed on the drum, and the fluid balancer including balancer housings having ring-shaped flow chambers partially filled with a fluid, and a plurality of guides disposed in the flow chambers, and the plurality of guides being separated from each other in the circumferential direction of the flow chambers,
wherein the plurality of guides includes first communication holes provided on inner peripheral sides of the balancer housings and second communication holes provided on outer peripheral sides of the balancer housings; and
an area of the second communication holes is more than 1% of a cross-sectional area of each of the flow chambers and less than 4% of the cross-sectional area of each of the flow chambers.

9. The washing machine according to claim 8, wherein a volume of the fluid filling each of the flow chambers is in the range of 32˜40% of a volume of each of the flow chambers.

10. A washing machine comprising:
a fluid balancer including balancer housings having ring-shaped flow chambers partially filled with a fluid,
wherein a volume of the fluid filling each of the flow chambers is in the range of 32˜40% of a volume of each of the flow chambers.

11. The washing machine according to claim 10, wherein the fluid balancer further include protrusions protruded from the inner peripheral sides of the balancer housings to the insides of the flow chambers.

12. The washing machine according to claim 10, further comprising a drum,
wherein the fluid balancer is installed at an upper end of the drum

13. The washing machine according to claim 10, wherein the flow chambers comprise a pair of flow chambers provided in parallel in the radial direction of the balancer housings.
